(19) United States
(12) Patent Application Publication
(10) Pub. No.: US 2004/0114260 A1
(43) Pub. Date: Jun. 17, 2004

(54) Vehicle side view mirror

(76) Inventor: Brian K. Bartnick, Ortonville, MI (US)

Correspondence Address: LAURA C. HARGITT, General Motors Corporation, Legal Staff, Mail Code 482-C23-B21, P.O. Box 300, Detroit, MI, 48265-3000, US

(21) Appl. No.: 10/322,037

(22) Filed: Dec. 17, 2002

(51) Int. Cl. G02B 5/10

(52) U.S. Cl. 359/864; 359/866; 359/868

(57) ABSTRACT

A side view mirror assembly and method of adjustment for use on an automotive vehicle. The mirror assembly includes a support for mounting to a side of the vehicle and supporting a reflective surface. The reflective surface has an outboard region, and an inboard region between the side of the vehicle and the outboard region. The inboard region is generally convex shaped, while the outboard region forms the majority of the reflective surface and is generally flat. A vehicle operator can tilt the reflective surface relative to the vehicle such that a portion of the side of the vehicle can be seen by a reflection from the inboard region. The outboard region can then be used to view other vehicles behind and to the side of the vehicle.

### BACKGROUND OF INVENTION

The present invention relates to mirrors used in vehicle applications, and more particularly to side view mirrors mounted on the sides of vehicles.

A typical automotive vehicle includes both a rear view mirror mounted near the center of the vehicle on the windshield, and a pair of side view mirrors, one mounted on each side near the vehicle front doors. The rear view mirror allows the driver to generally see other vehicles that are straight behind or behind and only slightly off to the side of the vehicle. The side view mirrors generally allow the drive to see vehicles behind the vehicle in adjacent lanes of the road. Depending upon how these mirrors are positioned for the driver, though, there may be a blind spot created between the view in the side view mirror and the driver's peripheral vision. The blind spot may be a concern for some drivers, for example, when another vehicle is passing the driver's vehicle. When it is directly behind, the driver can see the other vehicle in the rear view mirror. However, as this other vehicle moves to an adjacent lane and begins to pass the driver's vehicle, it moves out of view from the rear view mirror and into view of a side view mirror—then as it moves forward, it moves out of view of the side view mirror, but cannot be seen in the driver's peripheral vision. At that point, some drivers may be concerned that they cannot see the other vehicle, either directly or in one of the mirrors.

To minimize any potential blind spots, some have shaped the entire passenger side mirror reflective surface so that it has a convex shape, in order to increase the viewing area. But the convex mirror makes objects appear closer than they actually are, and is not desirable for the driver side mirror because it distorts the driver's depth perception. Others have attempted to minimize the blind spot by employing much larger side view mirrors—but this is not an acceptable solution for many vehicles, and in particular passenger cars, since it increases the aerodynamic drag on the vehicle, costs and weighs more, and may be unattractive. For large trucks, some have mounted two side view mirrors on each side, with one on top of the other—the first being flat, and the second being convex. But again, for automotive vehicles, this may not be an acceptable solution.

Still others have suggested a complicated process for adjusting the position of the side mirrors for the driver in order to optimally reduce the blind spot. The process involves the driver taking different specific positions in the vehicle when one is adjusting the driver side mirror and the passenger side mirror. However, this process is time consuming, and does not allow the driver to see a side of his vehicle in either of the side view mirrors. Many drivers like to be able to see along the side of their vehicles through the side view mirrors in order to give a reference for the adjustment of the mirror, and to reduce a perceived blind spot between the rear view mirror and the particular side view mirror even though this potential blind spot is very small and should not be a concern. Plus many are unlikely to go through the steps of a complicated process to readjust the side view mirrors. So, as a result, many drivers will adjust both side view mirrors to be able to see along the sides of their vehicles, even though this produces blind spots.

Consequently, it is desirable to have side view mirrors that overcome the potential drawbacks of current side view mirrors, and in particular, it is desirable to have a side view mirror that will allow a driver to adjust the mirror to see along that side of the vehicle while still minimizing any potential blind spot between the view in a side view mirror and the driver's peripheral vision.

### SUMMARY OF INVENTION

In its embodiments, the present invention contemplates a mirror assembly for mounting on a side of a vehicle. The mirror assembly includes a support adapted for securing the mirror to the side of the vehicle. The mirror assembly also includes a reflective surface supported by the support and having a first portion forming an inboard region adapted to be adjacent to the side of the vehicle, and a second portion forming an outboard region adapted to be farther from the side of the vehicle than the inboard region. The inboard region is formed in a generally convex shape and the outboard region is formed in a generally flat shape.

In its embodiments, the present invention also contemplates a method of adjusting a side view mirror assembly mounted on a side of a vehicle. The method comprises the steps of: providing a reflective surface on the mirror assembly having an outboard region, and an inboard region that is closer to the vehicle than the outboard region, with the outboard region encompassing a majority of the reflective surface and being generally flat, and with the inboard region being convex in shape; occupying the vehicle in a position of a vehicle operator; and tilting the reflective surface relative to the vehicle such that a portion of the side of the vehicle can be seen by a reflection from the inboard region without seeing a portion of the side of the vehicle by a reflection from the outboard region.

An advantage of the present invention is that a side view mirror on a vehicle can be adjusted to allow a vehicle operator to see along a side of the vehicle as a reference point when looking in the side view mirror, while still minimizing any potential blind spot between a view in a side view mirror and a driver's peripheral vision.

Another advantage of the present invention is that accurate depth perception is maintained in the generally flat region of the side view mirror while allowing for the convex region of the mirror to provide a vehicle operator with a view of the side of the vehicle as a reference.

A further advantage of the present invention is that the size of the reflective surface on the rear view mirror can remain relatively small, while still allowing for minimizing of the blind spot. This allows for an aesthetically pleasing shape for the mirror and its support, while keeping the cost of the mirror assembly low.

Still another advantage of the present invention is that the curvature in an inboard convex region of the reflective surface can be a simple curvature, since this region is only used to assist with alignment of the mirror rather than to view other vehicles while driving. This keeps fabrication of the reflective surface relatively simple and inexpensive, allowing for a one piece reflective surface.

Yet another advantage of the present invention is that the side view mirror allows for a simple process for the driver to align the mirror as he prefers, while minimizing any potential blind spots. Also, since the curved portion is only a small part of the reflective surface, and the main portion of the reflective surface is flat, drivers will not have to get used to judging distances to the other vehicles, as is the case when drivers were employing the convex portion of the mirror to view the other vehicles.

### BRIEF DESCRIPTION OF DRAWINGS

FIG. 1 is a schematic plan view of a vehicle with mirrors in accordance with the present invention.

FIG. 2 is a schematic plan view of a driver side mirror in accordance with the present invention.

FIG. 3 is a schematic rear elevation view of a driver side mirror in accordance with the present invention.

### DETAILED DESCRIPTION

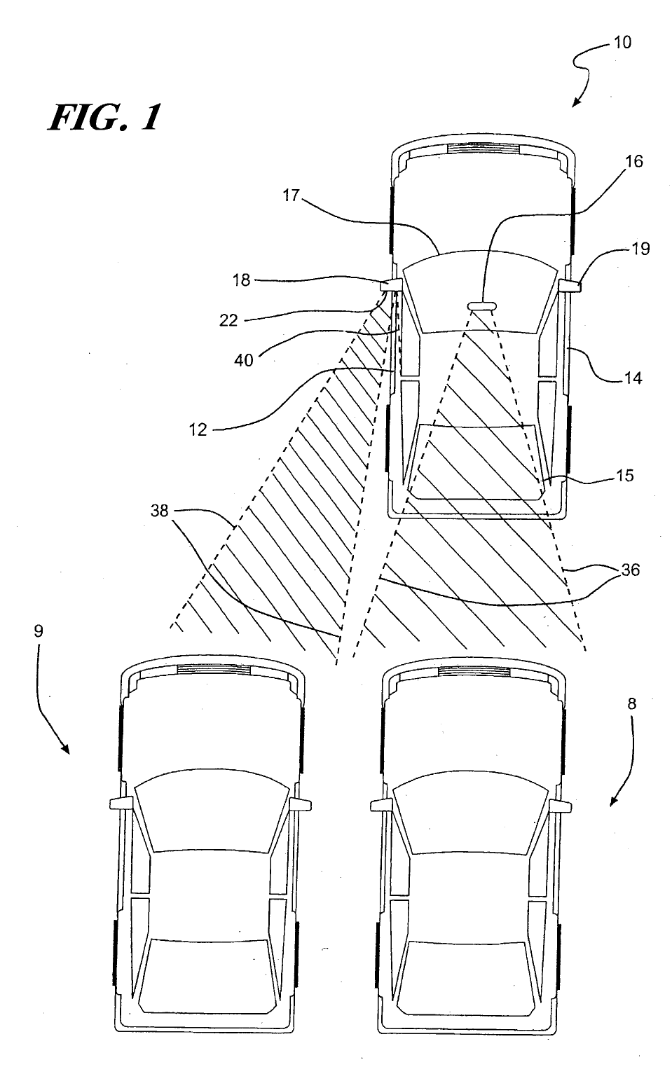

FIG. 1 illustrates a vehicle 10 in front of two other vehicles 8 and 9. The vehicle 10 has a driver side 12 and a passenger side 14. The vehicle includes a rear view mirror 16, typically mounted to a vehicle windshield 17 for viewing through the rear window 15 of the vehicle 10. Mounted to the driver side 12 of the vehicle 10 is a driver side, side view mirror assembly 18. Mounted to the passenger side 14 of the vehicle 10 is a passenger side, side view mirror assembly 19.

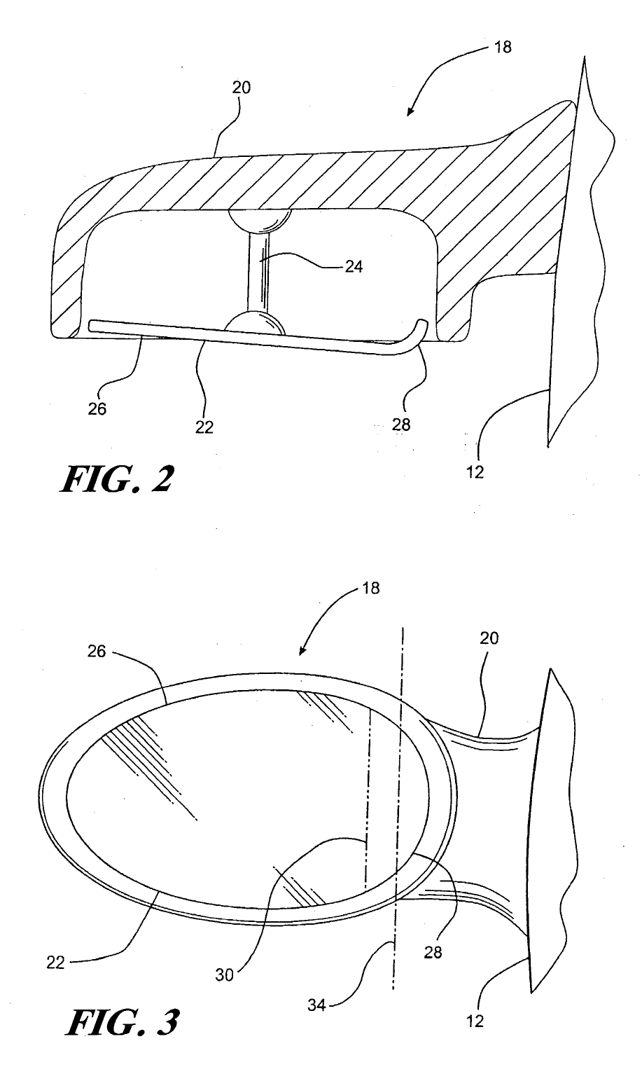

FIGS. 2 and 3 illustrate the driver side, side view mirror assembly 18 in more detail. Since the present invention is particularly advantageous when applied to a driver side mirror, this is the side that will be discussed. Of course, it is equally applicable for the passenger side, side view mirror assembly 19 as well. The assembly 18 includes a driver side mirror support 20, a driver side reflective surface 22, and a mirror adjuster 24 mounted between the mirror support 20 and the reflective surface 22. The adjuster 24 may be manually operated or driven by a motor and electronic circuit, but is generally conventional and so it will not be discussed further herein.

The reflective surface 22 includes an outboard region 26, and an inboard region 28 that is between the outboard region 26 and the side 12 of the vehicle. A phantom line in FIG. 3 indicates generally a transition 30 between the two adjacent regions 26, 28. This transition 30 can be just the location where the two regions meet without any visual indication on the reflective surface 22, or a line can be marked on the actual reflective surface 22 in order to allow the driver to more readily distinguish between the two regions 26,28. The inboard region 28 is convex on its reflective surface and transitions to a flat mirror on the outboard region 26 for the greater portion of the viewing area of the reflective surface. While the inboard region 28 is shown with a particular curvature in FIG. 2, the actual amount of curvature may vary, depending upon the particular vehicle application, the size of the reflective surface 22, and other factors.

Preferably, substantially more than a majority of the reflective surface 22 is comprised of the flat outboard region 26, and the convex inboard region 28 is relatively small. This is preferred since the convex portion is generally only used for adjusting the reflective surface 22 in order to give the driver a reference point along the side 12 of the vehicle. Preferably, the convex inboard region 28 is only about ten percent of the reflective surface 22, but can be in a range of more or less—for example, between five and twenty five percent of the total reflective surface 22. Again, the actual amount of convex surface relative the amount of flat surface will vary depending upon the vehicle, size of mirror, and other factors.

Also, preferably, the inboard region 28 only curves in one direction, about a generally vertical axis 34, since the inboard region 28 is generally only used for alignment of the mirror. This makes the transition 30 between the inboard region 28 and the outboard region 26 smooth, which allows for the reflective surface 22 to be easily formed as a single, integral part. Typically, the reflective surface 22 is formed from glass coated on its back side with a reflective material—although, other suitable materials may also be used.

The operation of the mirror assembly 18 of FIGS. 1-3 will now be discussed. Again, while this discussion is directed to the driver side mirror assembly 18, it is also applicable to the passenger side assembly 19. The driver sits in the vehicle 10 in a position ready for operating the vehicle. The driver then adjusts the mirror reflective surface 22 by manipulating the mirror adjuster 24 (which, as stated above, is a conventional mechanical or electronic mechanism) until the driver can see some portion along the side 12 of the vehicle 10 in the inboard region 28 of the reflective surface 22. The term “along the side of the vehicle” is used herein to refer to a portion of a driver field of view, and does not necessarily mean that the driver can see all of the side of the vehicle—only that the driver can see some portion of the vehicle along that side. Since the inboard region 28 is convex shaped, the driver will be able to see a portion of the side of the vehicle with the reflective surface 22 angled outward father than it would otherwise be if the entire reflective surface was flat. With the outboard region 26 angled outward an additional amount, the field of view of the driver to the side of the vehicle 10 will be increased. And, since the inboard region 28 is small relative to the outboard region 26, the outboard region 26 will be sufficient for the driver to see other vehicles without any distortion in depth perception that occurs with reflective surfaces that are other than flat. Thus, the convex inboard portion 28 serves to perform an alignment function while the flat outboard portion 26 is used for viewing the other vehicles. In order to assist the driver with distinguishing between the outboard region 26 and the inboard region, the transition line 30 may be a line marked on the reflective surface 22.

FIG. 1 illustrates with phantom lines the general field of view 36 for the rear view mirror 16 and the general field of view 38 for the drivers side, side view mirror 18. As can be seen, since the reflective surface 22 is angled outward more than it would be with a flat mirror, the field of view to the side of the vehicle is increased. This will allow for a reduced blind spot off to the side of the vehicle 10. But, as can be seen from the phantom line for the inboard region 28 representing this field of view 40, the driver will be able to see the side 12 of the vehicle 10 as a reference point.

While certain embodiments of the present invention have been described in detail, those familiar with the art to which this invention relates will recognize various alternative designs and embodiments for practicing the invention as defined by the following claims.

1. A mirror assembly for mounting on a side of a vehicle comprising:
a support adapted for securing the mirror to the side of the vehicle; and
a reflective surface supported by the support and having a first portion forming an inboard region adapted to be adjacent to the side of the vehicle and a second portion forming an outboard region adapted to be farther from the side of the vehicle than the inboard region; with the inboard region formed in generally a convex shape and the outboard region formed in a generally flat shape.

2. The mirror assembly of claim 1 wherein the vehicle includes a driver side and a passenger side, and the support is adapted to mount on the driver side.

3. The mirror assembly of claim 1 wherein the vehicle includes a driver side and a passenger side, and the support is adapted to mount on the passenger side.

4. The mirror assembly of claim 1 wherein the reflective surface is adjustable relative to the support.

5. The mirror assembly of claim 1 wherein the inboard region and the outboard region of the reflective surface are formed as an integral piece.

6. The mirror assembly of claim 5 wherein the inboard region is generally curved in only one direction.

7. The mirror assembly of claim 6 wherein the inboard region is about five to twenty five percent of the reflective surface.

8. The mirror assembly of claim 1 wherein the inboard region is generally curved in only one direction.

9. The mirror assembly of claim 1 wherein the inboard region is about five to twenty five percent of the reflective surface.

10. A vehicle comprising:
a first side;
a second side;
a support for securing the mirror to the first side of the vehicle; and
a reflective surface supported by the support and having a first portion forming an inboard region adjacent to the first side of the vehicle and a second portion forming an outboard region farther from the first side of the vehicle than the inboard region; with the inboard region formed in generally a convex shape and the outboard region formed in a generally flat shape.

11. The vehicle of claim 10 wherein the first side is a driver side and the second side is a passenger side, and the support is adapted to mount on the driver side.

12. The vehicle of claim 10 wherein the inboard region and the outboard region of the reflective surface are formed as an integral piece.

13. The vehicle of claim 10 wherein the inboard region is generally curved in only one direction.

14. The vehicle of claim 13 wherein the curvature of the inboard region is about a generally vertical axis.

15. The vehicle of claim 14 wherein the inboard region is about five to twenty five percent of the reflective surface.

16. The vehicle of claim 10 wherein the vehicle further includes a second support mounted on the second side, and a second reflective surface supported by the second support and having a third portion forming a second inboard region adjacent to the second side of the vehicle and a fourth portion forming a second side outboard region farther from the second side of the vehicle than the second side inboard region, with the second side inboard region formed in generally a convex shape and the second side outboard region formed in a generally flat shape.

17. The vehicle of claim 10 wherein the inboard region is about five to twenty five percent of the reflective surface.

18. A method of adjusting a side view mirror assembly mounted on a side of a vehicle, the method comprising the steps of:
providing a reflective surface on the mirror assembly having an outboard region, and an inboard region that is closer to the vehicle than the outboard region, with the outboard region encompassing a majority of the reflective surface and being generally flat, and with the inboard region being convex in shape;
occupying the vehicle in a position of a vehicle operator; and
tilting the reflective surface relative to the vehicle such that a portion of the side of the vehicle can been seen by a reflection from the inboard region without seeing a portion of the side of the vehicle by a reflection from the outboard region.

19. The method of claim 18 wherein the step of providing a reflective surface includes the inboard region being less than twenty five percent of the reflective surface.

20. The method of claim 18 wherein the step of providing a reflective surface includes the inboard region being curved in generally only one direction.
